(19) United States
(12) Patent Application Publication
(10) Pub. No.: US 2025/0371677 A1
(43) Pub. Date: Dec. 4, 2025

(54) A LINEAR TRANSFORMATION MODEL TRAINED ON UNPAIRED DATA USING DIFFUSION MODELS

(71) Applicant: Google LLC, Mountain View, CA (US)

(72) Inventors: Andreas Franz Lugmayr, Mountain View, CA (US); Xuan Luo, Seattle, WA (US); Anne Isabelle Marie Simone Menini, Mountain View, CA (US); Weijuan Xi, Sunnyvale, CA (US); Desai Fan, Snohomish, WA (US); Rahul Garg, Sunnyvale, CA (US); Andeep Singh Toor, Fremont, CA (US)

(21) Appl. No.: 19/123,564

(22) PCT Filed: Nov. 11, 2023
(86) PCT No.: PCT/US2023/079451

§ 371 Date: Apr. 23, 2025

Related U.S. Application Data
(60) Provisional application No. 63/383,416, filed on Nov. 11, 2022.

(51) Int. Cl. G06T 5/60; G06T 5/70; G06T 5/77

(52) U.S. Cl. CPC G06T 5/60; G06T 5/70; G06T 5/77; G06T 2207/20081

(57) ABSTRACT

A method can include receiving an image including a label identifying inclusion of at least one opacity artifact is received, generating a transformed semantic latent space based on the image using a linear transformation model. generating a noisy image based on the image, generating a first estimated image based on the transformed semantic latent space using a diffusion model, generating a second estimated image based on the transformed semantic latent space and the noisy image using the diffusion model, and training the linear transformation model based on the first estimated image, the second estimated image, and a loss that enforces a linear change in the linear transformation model.

### CROSS-REFERENCE TO RELATED APPLICATION

This application claims priority to U.S. Provisional Patent Application No. 63/383,416, filed on Nov. 11, 2022, the disclosure of which is incorporated by reference herein in its entirety.

### FIELD

The present disclosure relates to image manipulation and more specifically, to a robust method for realistically removing eyeglass glare from an input image.

### BACKGROUND

Glare and reflection (opacity artifacts) on eyeglasses are common in input images, such as portrait photos, video conference streams, or other settings where a subject's face is captured in an image. Unfortunately, these artifacts (glare and reflection) are often inevitable when capturing images in presence of strong sunlight, bright lights, nearby screens, etc. The opacity artifacts obscure the eyes of the subject, affecting portrait's aesthetics, and interfere with perceiving the subject's expressions. Removing such artifacts computationally from images has significant value, as it enhances the image's quality and broadens the circumstances in which good portrait photos and good subject-centered videos can be taken.

### SUMMARY

In some aspects, the techniques described herein relate to a method for removing opacity artifacts (e.g., glare, reflection) from the lenses in an image. Specifically, techniques train a glare-removal model that learns to remove reflection given only binary class labels, i.e., collection of images with and without reflection. In particular, a diffusion autoencoder is used to learn a latent embedding of input images, and then edit the embedding to remove opacity artifacts. Because opacity artifacts are additive in the image space, implementations can include a novel linearity loss that uses the additive nature of opacity artifacts to find the edit direction. To further constrain the edit to remove opacity artifacts without changing other attributes, or while minimizing change to other attributes, implementations may include a masked transformation in feature space of the denoising network to restrict the edit to the eye region. Implementations can create pixel-aligned paired data that provides more realistic resulting images than prior approaches that rely on paired data.

In a general aspect, a device, a system, a non-transitory computer-readable medium (having stored thereon computer executable program code which can be executed on a computer system), and/or a method can perform a process with a method including receiving an image including at least one opacity artifact and generating an enhanced image by minimizing the at least one opacity artifact using a trained linear transformation model. The trained linear transformation model is trained using a first estimated image generated based on a semantic latent space using a diffusion model, a second estimated image generated based on the semantic latent space and a noisy image using the diffusion model, a loss that enforces a linear change in the trained linear transformation model, and the semantic latent space and the noisy image are generated using a same training image.

In another general aspect, a device, a system, a non-transitory computer-readable medium (having stored thereon computer executable program code which can be executed on a computer system), and/or a method can perform a process with a method including receiving an image including a label identifying inclusion of at least one opacity artifact is received, generating a transformed semantic latent space based on the image using a linear transformation model. generating a noisy image based on the image, generating a first estimated image based on the transformed semantic latent space using a diffusion model, generating a second estimated image based on the transformed semantic latent space and the noisy image using the diffusion model, and training the linear transformation model based on the first estimated image, the second estimated image, and a loss that enforces a linear change in the linear transformation model.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates a computing device that includes a glare removal model according to a possible implementation of the present disclosure.

FIG. 2 illustrates a data flow diagram of a method for determining the transformation of a glare removal model according to a possible implementation of the present disclosure.

FIG. 3 illustrates differences between a global transformation and a regional transformation according to a possible implementation of the present disclosure.

FIG. 4 illustrates a global transformation applied to the semantic latent space by a network.

FIG. 5 illustrates a regional transformation applied to the semantic latent space by a network according to a possible implementation of the present disclosure.

FIG. 6 is a block diagram of a method of generating an enhanced image according to an example implementation.

FIG. 7 illustrates a block diagram of a method of training a diffusion model according to at least one implementation of the present disclosure.

FIG. 8A and 8B compare the output of the presently described techniques with glare removal techniques that rely on paired inputs.

The components in the drawings are not necessarily to scale relative to each other. Like reference numerals designate corresponding parts throughout the several views.

### DETAILED DESCRIPTION

Implementations relate to a system and method for removing opacity artifacts from an input image. Specifically, implementations relate to training a machine-learned model for removing opacity artifacts in an image that does not rely on paired input images. In other words, one image can be used in each training iteration (e.g., no ground-truth image is used). For example, opacity artifacts can be associated with a glare. Therefore, some implementations relate to removing glare from an image. For example, some implementations can relate to training a machine-learned model for removing glare from glasses worn by a subject in an image where the training technique does not rely on paired input images. Opacity artifacts can include, for example, glare, shadows, and/or image discontinuities. In some implementations, opacity artifacts can be human skin conditions like, for example, rashes, hives, vitiligo, eczema, and the like. In some implementations, opacity artifacts can be environmental discontinuities like, for example, a tree missing some leaves, a wall discoloration, a patch of grass missing, and the like. Other opacity artifacts are within the scope of this disclosure. Some implementations not only fill in missing information but can also change portions of the image without deforming the portion. For example, the described techniques can be used to change the color of the leaves of a tree without deforming the leaves. (e.g., change style from summer to fall).

Prior machine-learned methods of opacity artifact reduction/elimination rely on paired images for pixel-wise supervised learning. In such supervised learning, one input image represents the ground-truth or the desired output image (without an opacity artifact) and the other image represents the same image with the opacity artifact. The model is then trained to produce the ground-truth image given the input image. However, there exists a technical problem in that the quantity of paired images used in training affects the quality of the model is large, and the cost and difficulty of obtaining a sufficient quantity of real-world (e.g., non-synthetic) pairs of images with and without an opacity artifact is difficult. Therefore, the ability to make a robust model from such real-world data is limited.

To address the lack of hand-curated image pairs for supervised training, other prior methods have generated synthetic pairs of images, e.g., using physics-based rendering, or taking images with and without a glass plane. These methods, however, are unsuitable for creating pixel-aligned paired data for opacity artifacts. For example, it is difficult to model eyeglasses reflection due to the wide variety of lens geometry, tint, and coating which can introduce effects like distortion due to refraction, color casts, etc. Further, capturing a pair of pixel-wise aligned images with and without eyeglasses reflection is difficult because the human subject is likely to move between captures and removing the source of reflection, e.g., a bright screen, will alter the lighting of the entire scene.

In contrast, disclosed implementations include a technical solution having a model that learns to remove opacity artifacts (e.g., glare and reflection) from images without paired input-output examples. In place of such supervised learning using image pairs, the technical solution can include some implementations that learn a linear transformation in a semantic latent space used by generative approaches in synthesis and restoration. In some implementations, the model (in inference mode) encodes an input image into semantic and stochastic latent space (sometimes referred to as a latent space or a semantic latent space), applies the learned linear transformation into the semantic latent space (the output sometimes referred to as a latent space or a transformed semantic latent space), and decodes the image using the original stochastic latent. The resulting linearity loss and latent masked semantic transformation helps retain the appearance of the regions of the image without an opacity artifacts while removing only the opacity artifacts, resulting in a more realistic output image. Once trained, the model can be pushed to/included in various client devices for various purposes to remove opacity artifacts from images, photos, and/or video. For example, the model can be pushed to/included in a smartphone camera to remove opacity artifacts (e.g., glare, shadows, and the like) from photos, used in a webcam to remove opacity artifacts (e.g., glare, shadows, and the like) from a video conference feed, etc.

A diffusion autoencoder can include a diffusion model. A diffusion model can be configured to gradually convert data (e.g., image data) into noise, and then train a neural network to learn to invert the noisy data to the original data type. Increments can include reducing the noise of the noisy data by replacing some of the information masked by the noise. In some implementations, starting from pure noise and incrementing through the diffusion model can generate new data.

In some implementations a diffusion autoencoder (such as DiffAE) can be modified with a semantic and stochastic latent space. In some implementations, the diffusion model can be modified with a semantic and stochastic latent space. Given unpaired sets of images from two domains, a diffusion autoencoder can learn a latent direction and transform images from one domain to another by editing the latent code in that direction. However, because the latent edit is global and the two domains often contain some unsolicited bias, such edits often change the image more than desired. Examples for such distortions are altering the identity, head pose and deforming the 3D shape. Because of the additive nature of reflection, implementations include a novel linearity loss to ensure that any semantic edit along the latent edit direction may only yields images with varying glare strength. In other words, the output image can be an image that is a weighted blend of images with and without opacity artifacts.

This can lead to a constrained optimization that penalizes for changes that are not linear in image space such as pose changes, 3D shape changes, etc. In order to spatially restrict the edit to a region that includes an opacity artifact, some implementations can include a feature transformation in the diffusion model. While some diffusion autoencoder approaches can apply a channel-wise weighting to the feature in the diffusion model, implementations expand this to a pixel-wise transformation. This can ensure application of the opacity artifact removal transformation on regions that can contain opacity artifact and thus avoids spurious changes in regions that do not contain opacity artifact. Implementations can thus include a diffusion-based opacity artifact (e.g., reflection and glare) removal method capable of learning from unpaired sets of images with and without opacity artifacts.

Some implementations can include a linearity loss, which constrains the search in latent space to directions that do not deform the image. In other words, the linearity loss can minimize or eliminate changes to the input image other than opacity artifact removal. Some implementations thus enable diffusion autoencoders to apply locally confined semantic editing. The benefit of the described solutions can be that some implementations outperform methods that require paired training data and provide significant improvement when generalizing to previously unseen input images, i.e., in the wild.

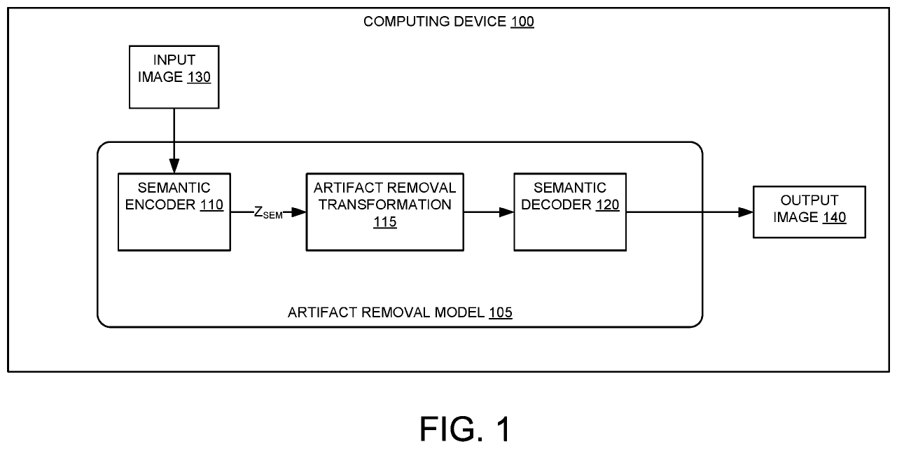

FIG. 1 illustrates a computing device 100 that includes an artifact removal model 105 trained to remove opacity artifacts using the disclosed techniques. The artifact removal model 105 includes a semantic encoder 110, artifact removal transformation 115, and a semantic decoder 120. The semantic encoder 110 can be a diffusion autoencoder (sometimes referred to as a DiffAE) configured to encode an input image 130 into a semantic and stochastic latent space. The input image 130 can be an image captured by a camera included in the computing device 100. The input image 130 can be an image captured by another computing device and transmitted to the computing device 100. The input image 130 can be an image (frame) of a video stream. As used herein, the latent space can be a feature vector referred to by the notation zₛₑₘ (sometimes referred to as a latent space or a semantic latent space). The artifact removal transformation 115 can represent a locally selected transformation applied to the latent space, as discussed herein. This transformation can include the learned linearity loss, which minimizes changes to the input image, as discussed herein. Once the image has been modified in the latent space, decoder 120 can be configured to convert the image from the latent space to output image 140.

Similar to other generative models like Generative Adversarial Networks and Normalizing Flows the generative diffusion models, such as artifact removal model 105, can use a Gaussian latent space. Differently from other methods, artifact removal model 105 does not generate an image in one network pass from a Gaussian latent space, but traverses multiple latent spaces spanned by a Markov Chain of Gaussian latent spaces. The inference process can therefore be an iterative denoising method starting from pure noise. During training the Markov Chain can be used to generate paired samples of an image from the dataset x₀ and one of its latent representations xₜ. The intermediate representation xₜ can be obtained by t times sampling from the Gaussian distribution:

$$q ( {x}_{t} \vert {x}_{t - 1} ) = ( \sqrt{1 - {β}_{t}} {x}_{t - 1} , {β}_{t} I )$$

This process of adding noise follows a noise schedule defined by βₜ;t ε 0, . . . , T−1. The noise schedule can include steps that can add independent Gaussian noise. Therefore, it is equivalent to directly sample x from xo with the variance. This leads to the following distribution:

$$q ( {x}_{t} \vert {x}_{o} ) = 𝒩 ( {x}_{t} ; \sqrt{{\overline{α}}_{t}} {x}_{0} , ( 1 - {\overline{α}}_{t} ) I ) \qquad ( 1 )$$

The reverse process can be parameterized in a way that the model ϵ_{θ} can be trained to estimate the noise ϵ˜ [symbol] (0,1) used to sample x₀. While the inference process can be stochastic, a deterministic technique of inverting the process can be represented as follows:

$${x}_{t - 1} = \sqrt{{α}_{t - 1}} \frac{{x}_{t} - \sqrt{1 - {α}_{t}} {ϵ}_{θ}^{t} ( {x}_{t} )}{\sqrt{{α}_{t}}} + \sqrt{1 - {α}_{t - 1}} {ϵ}_{θ}^{t} ( {x}_{t} ) \qquad ( 2 )$$

The training objective can be a simplified version of the variational lower bound on the log likelihood of q(x_{1:T}|x₀) for the noise ϵₜ added in time step t resulting in:

$${L}_{simple} = {\sum }_{t = 1}^{T} {{x}_{0} , {ϵ}_{t}}_{} [ {‖ {ϵ}_{θ} ( {x}_{t} , t , {z}_{s e m} ) - {ϵ}_{t} ‖}_{2}^{2} ] \qquad ( 3 )$$

A deterministic technique to encode a sample into the Gaussian latent space can be derived using this form. However, manipulations of the obtained latent may not lead to a semantically meaningful change in an image space. Therefore, a semantic latent zₛₑₘ can be developed, which encodes the image into a one-dimensional (1D) feature vector used as a conditional input to the noise prediction model ϵ_{θ} (xₜ, t, zₛₑₘ) using the following parameterization:

$${f}_{θ} ( {x}_{t} , t , {z}_{s e m} ) = \frac{{x}_{t} - \sqrt{1 - {α}_{t}} {ϵ}_{θ}^{t} ( {x}_{t} , t , {z}_{s e 𝔪} )}{\sqrt{{α}_{t}}} \qquad ( 4 )$$

When substituting it to the reverse process it becomes the following:

$${p}_{θ} ( {x}_{t - 1} \vert {x}_{t} , {z}_{s e m} ) = \{ \begin{matrix}( {f}_{θ} ( {x}_{1} , 1 , {z}_{sem} ) , 0 ) , & if t = 1 \\ q ( {x}_{t - 1} \vert {x}_{t} , {f}_{θ} ( {x}_{t} , t , {z}_{sem} ) , & otherwise\end{matrix} \qquad ( 5 )$$

With this the encoding process for the Gaussian latent can be represented as follows:

$${x}_{t + 1} = \sqrt{{α}_{t + 1}} {f}_{θ} ( {x}_{1} , 1 , {z}_{s e m} ) + \sqrt{1 - {α}_{t + 1}} {ϵ}_{θ} ( {x}_{1} , 1 , {z}_{s e m} ) \qquad ( 6 )$$

Classification Loss: The autoencoder can be used to manipulate images using a linear transformation in latent space. This transformation can be learned implicitly by training a classifier on the semantic latent zₛₑₘ. To obtain the class probability p the following a single fully connected layer is used as follows:

$$p ( {z}_{s e m} ) = {\sum }_{i} ( {z}_{s e m , i} {w}_{cls , i} {b}_{cls , i} ) \qquad ( 7 )$$

For a binary label y (e.g., artifacts, glare, no artifacts, no glare) the binary cross entropy of the probability p is calculated as follows:

$${L}_{cls} = - ( y log ( p ) + ( 1 - y ) log ( 1 - p ) ) \qquad ( 8 )$$

The resulting transformation between one class to another in latent space is given by z_{sem,l}−T_{θ}(zₛₑₘ)=w ⊙ sₑₑₘ.

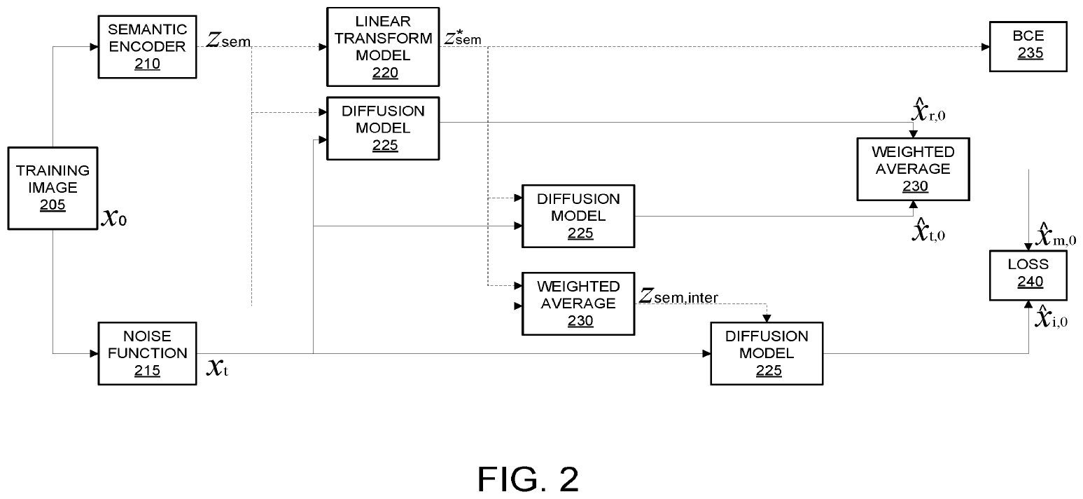

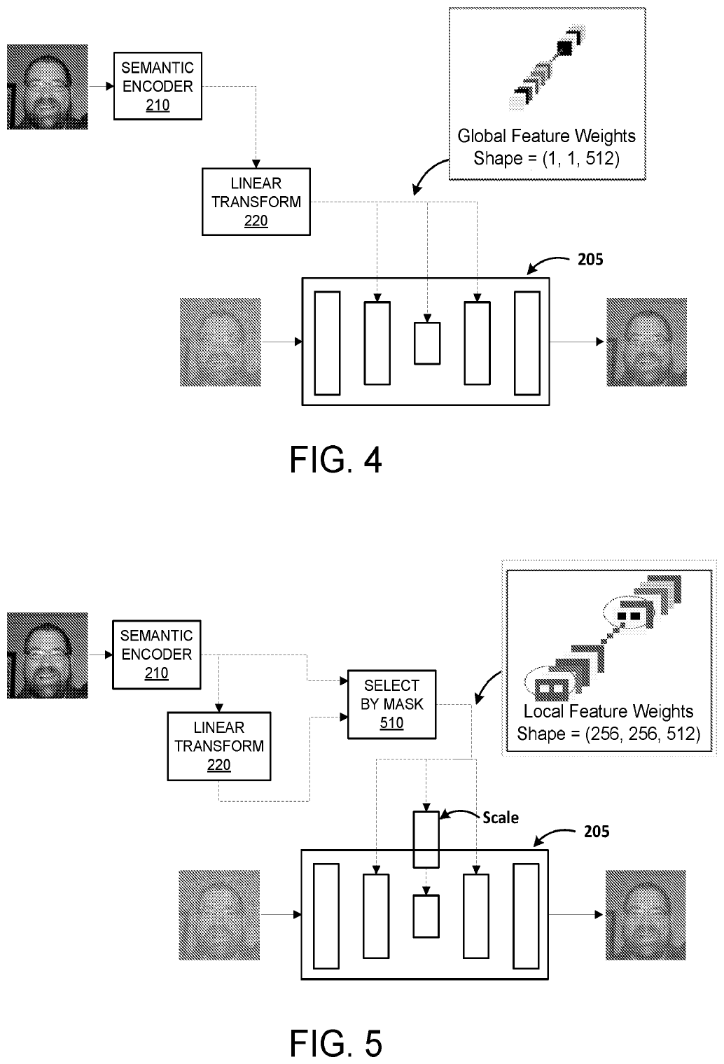

FIG. 2 illustrates a flow diagram of a method for determining (training) an opacity artifact(s) removal transformation, e.g., artifact removal transformation 115 of FIG. 1. This transformation can represent the semantic latent space direction for opacity artifact removal. As shown in FIG. 2, the flow diagram includes a semantic encoder 210, a noise function 215, a linear transform model 220, a diffusion model 225 (described with regard to FIGS. 4 and 5), a weighted average 230, a classification loss (BCE) 235, and a loss 240.

The linear transform model 220 can be configured as the opacity artifact removal transformation. The linear transform model 220 can be implemented as a linear transformation of the form T_{θ} as the opacity artifact removal transformation. The parameters θ of the linear transformation T_{θ} can be optimized using classification loss and linearity loss. The classification loss can be based on labels given to the images 205 (x₀) used in training. The training images 205 can be classified as either including opacity artifact(s) (e.g., glare) or not including opacity artifact(s) (e.g., not including glare or in some cases no glare, light glare, strong glare). The training images 205 are not paired. In other words, one image is used in each training iteration (e.g., no ground-truth image is used); rather each individual image 205 is labeled as either including an opacity artifact(s) or not including an opacity artifact(s). Because the images 205 are not paired sufficient training images can be obtained with minimal difficulty. The BCE 235 can be used to optimize the linear transformation and can be determined from these labels. The linearity loss can be configured to penalize differences between the weighted average 230 of the input image with and without opacity artifact(s) in the image space and the image reconstructed from the weighted average 230 of the original and transformed semantic latent (sometimes referred to as a latent space or a transformed semantic latent space). In the example of FIG. 2, the L₁ loss 240 is calculated on \hat{x}ᵢ, 0 and \hat{x}ₘ, 0. The losses (classification loss and linearity loss) can be combined as follows:

$$L = {L}_{cls} + {λ}_{lin} {L}_{lin} \qquad ( 9 )$$

Disclosed implementations can be configured to remove opacity artifacts in an image 130, 205 while preserving other attributes. Other attributes can include, for example, the identity of the person or background of the image. Implementations can achieve this by confining the region of the image on which the transformation takes place. Because this is a change confined to the region of the opacity artifacts, implementations incorporate this prior information. In an explanation of how to confine the region, the input image can be denoted as x, the mask with values {0, 1} as m, the pixel which should be affected by the transformation as m ⊙ x and the pixel which should be unaffected by (1−m) ⊙ x.

In each transition from xₜ₋₁ to xₜ for t>1 a global transformation algorithm uses the semantic latent zₛₑₘ as follows:

$${p}_{θ} ( {x}_{t - 1} \vert {x}_{t} , {z}_{s e m} ) = q ( {x}_{t - 1} \vert {f}_{θ} ( {x}_{t} , t , {z}_{s e m}^{*} ) ) {\hat{x}}_{r , 0} \qquad ( 10 )$$

The semantic latent used to translate the image to be of the label for which the classifier was trained can be obtained by zₛₑₘ*=Enc(x₀)+λw_{cls}, where w_{cls} are the weights of the classifier trained to classify the attribute that should be manipulated (zₛₑₘ* is sometimes referred to as a latent space or a transformed semantic latent space).

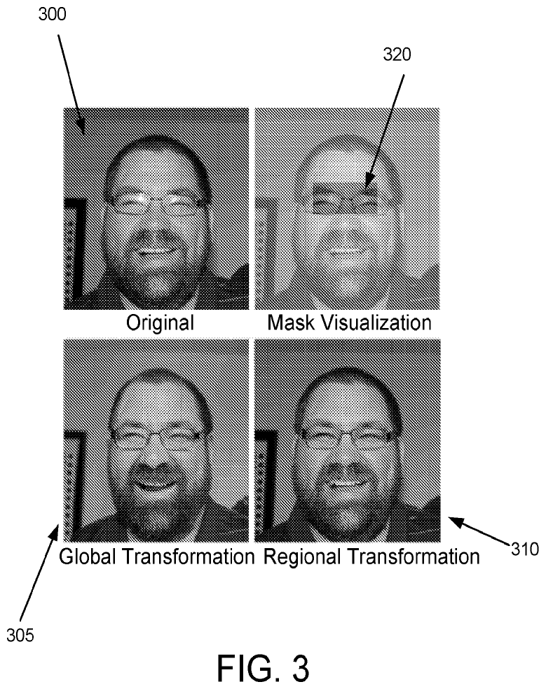

FIG. 3 illustrates a contrast between a global transformation and the regional transformation used in some disclosed implementations. FIG. 3 includes an original image 300 serving as the input image (e.g., image 130), an output image 305 representing a global transformation, and an output image 310 representing a regional transformation. As shown in FIG. 3 the global transformation resulting in output image 305 not only removes glare, but also changes other attributes of the image, such as the smile, hair, head shape, etc. To construct a method which better confines the transformation to the region of interest, implementations locate a region of interest, e.g., region 320 of FIG. 3, and confine the transformation to the region of interest, leaving the other areas unaffected.

FIG. 4 illustrates a global transformation applied to the semantic latent zₛₑₘ (sometimes referred to as a latent space or a semantic latent space) by a network f_{θ} of the diffusion model 225. As illustrated in FIG. 4, the global transformation approach uses the transformed semantic latent zₛₑₘ* (sometimes referred to as a latent space or a transformed semantic latent space) to weight the channels of the network f_{θ}. FIG. 5 illustrates a regional transformation applied to the semantic latent. In contrast to a global transformation, to better confine the transformation to the region of interest (i.e., the region of the input image that includes the opacity artifact, or the mask area), implementations first expand the channel-wise weighting to a pixel-wise weighting in all conditioned latent vectors and then apply the linear transformation T_{θ} only to the region of interest using a mask 510. FIG. 5 illustrates expansion of the channel weighting to pixel-wise weighting and using the mask 510 to select weather to choose the original semantic zₛₑₘ*=Enc(x₀) for a pixel or the transformed zₛₑₘ*=Enc(x₀)+λw_{cls}. Because it is applied at different scale levels of a UNet, resulting in different number of channels, a 1×1 convolution is employed to adapt the number of channels of zₛₑₘ to z_{sem,l}=T_{θ}(zₛₑₘ)=w ⊙ zₛₑₘ having the corresponding number of levels for each channel.

The original transformation is as follows:

$${h}^{( x , y , c )} = {{f}_{θ , l} ( {x}_{0} )}^{( x , y , c )} * {{T}_{θ} ( {z}_{sem , l} )}^{( c )} ; ∀ x , y , c \qquad ( 11 )$$

To apply a locally selected transformation, some implementations can expand the channel-wise weighting to a pixel-wise weighting. Implementations can accomplish this by either selecting the original

$${z}_{s e m}^{( c )}$$

or the transformed T_{θ}(zₛₑₘ)^{(c)} value according to the mask values m^{(x,y)} for each pixel (x,y) of this channel.

$${z}_{s e m}^{( x , y , c )} = \{ \begin{matrix}{z}_{sem}^{( c )} & if {m}^{( x , y )} = 0 \\ {{T}_{θ} ( {z}_{sem} )}^{( c )} & if {m}^{( x , y )} = 1\end{matrix} ; ∀ x , y , c \qquad ( 12 )$$

This results in the following regionally selective semantic transformation:

$${h}^{( x , y , c )} = {{f}_{θ , l} ( {x}_{0} )}^{( x , y , c )} * {z}_{s e m}^{( x , y , c )} ; ∀ x , y , c \qquad ( 13 )$$

Because the transformation is only applied to the regions m ⊙ x that can contain the opacity artifact(s), deformations outside of it that might be correlated with removing glare do not harm the overall image restoration. This property can then be used to find a transformation direction which is linear in image space. Some implementations can adapt the mask 510 for the different scale levels by applying nearest neighbor down-sampling.

The regional transformation approach just described spatially constraints the transformation to the eye region, but the glare removal transformation T_{θ} can still cause undesired deformations (e.g., of the glasses and eye region) as shown in FIG. 3. This is because other attributes of that region may be correlated with the opacity artifacts. For example, faces with glare are more likely to be looking up than those without glare. To constrain T_{θ} to only remove the opacity artifacts, implementations may exploit the fact that opacity artifact(s) removal (or addition) is a linear operation in image space. The linearity assumption implies that given an image pair with and without opacity artifact(s), one can obtain images with varying opacity artifact(s) strengths by considering different linear blends of the two images. On the other hand, for a good opacity artifact(s) removal direction, moving along it should also progressively remove opacity artifact(s). Hence, implementations can use multiple strengths of the linear transformation that converts one class to another in the latent space, and apply a loss criteria that enforces a linear change in image space.

Specifically, implementations sample an α ε [0; 1] and obtain an interpolation between glare and no-glare in the semantic latent space as follows:

$${z}_{s e m} = E n c ( {x}_{0} ) \qquad ( 14 a )$$

$${z}_{s e m}^{*} = {T}_{θ} ( {z}_{s e m} ) \qquad ( 14 b )$$

$${z}_{sem , inter} = α {z}_{s e m} + ( 1 - α ) {z}_{s e m}^{*} \qquad ( 14 c )$$

Using those semantic latent vectors, implementations can apply one iteration of the diffusion model to obtain the estimated final image \hat{x}₀ using the following settings:

$${\hat{x}}_{r , 0} = {f}_{θ} ( {x}_{t} , t , {z}_{s e m} ) \qquad ( 15 a )$$

$${\hat{x}}_{t , 0} = {f}_{θ} ( {x}_{t} , t , {z}_{s e m}^{*} ) \qquad ( 15 b )$$

$${\hat{x}}_{i , 0} = {f}_{θ} ( {x}_{t} , t , {z}_{s e m , inter} ) \qquad ( 15 c )$$

$${\hat{x}}_{m , 0} = {f}_{θ} ( α {x}_{r , t - 1} + ( 1 - α ) {x}_{t , t - 1} ) \qquad ( 15 d )$$

The resulting loss for linearity is the mean absolute difference between the interpolation in image space and rendering of the interpolation in the semantic latent space, with respect to the weights of the classifier:

$${L}_{lin} = {\sum }_{t = 1}^{T} 𝔼 [ {‖ {\hat{x}}_{i , 0} - {\hat{x}}_{m , 0} ‖}_{1} ] \qquad ( 16 )$$

Some implementations may be trained using subsets of datasets containing, for example, faces with glasses. Implementations may select images with the label “Human Face” and may preprocess and filter the images. The filtering includes rejecting low-quality images, extreme poses and very bright or dark images. Implementations may apply a detector for glasses to all remaining images and annotate the images with glasses according to the glare levels “no glare”, “light glare” and “strong glare”. In some implementations, tens of thousands of images may be used as the training input images. In some implementations, some of the images may add synthetic glare only to the lens region.

In an example implementation, the linear transformation can be trained on a single NVIDIA A100 GPU on images of size 256×256 and a batch size of 21. Implementations may fix the learning rate to 10⁻³ and train on 500k samples. For the linearity loss the transformation weight of T_{θ} is 0.3 and the implementation may sample from the uniform distribution [symbol] (0, 0.3). For inference the example implementations may precompute the semantic and stochastic conditional for efficiency. For hyper parameter tuning the example implementation use a small set of images, which are excluded from the test set and set the number of diffusion steps T to 250. For the final evaluation implementations may use 1000 diffusion steps.

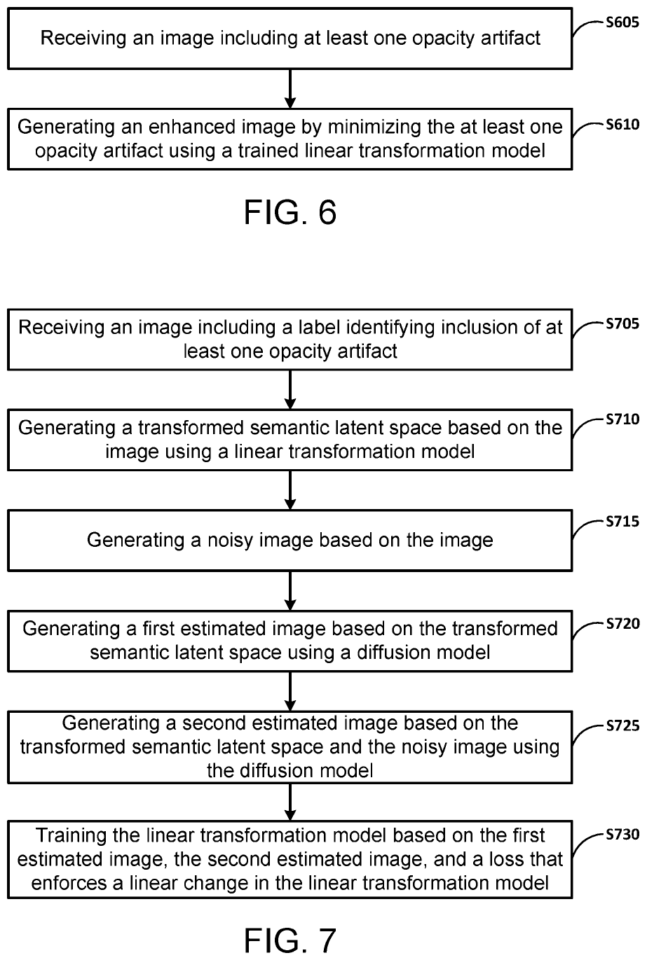

Example 1. FIG. 6 is a block diagram of a method of generating an enhanced image according to an example implementation. As shown in FIG. 7, in step S605 an image including at least one opacity artifact is received.

In step S610 an enhanced image is generated by minimizing the at least one opacity artifact using a trained linear transformation model. The trained linear transformation model is trained using a first estimated image generated based on a semantic latent space using a diffusion model, a second estimated image generated based on the semantic latent space and a noisy image using the diffusion model, a loss that enforces a linear change in the trained linear transformation model, and the semantic latent space and the noisy image are generated using a same training image.

Example 2. FIG. 7 is a block diagram of a method of training a diffusion model according to an example implementation. As shown in FIG. 7, in step S705 an image including a label identifying inclusion of at least one opacity artifact is received. In step S710 a first latent space or transformed semantic latent space is generated based on the image using a linear transformation model. In step S715 a noisy image is generated based on the image. In step S720 a first estimated image is generated based on the first latent space using a diffusion model. In step S725 a second estimated image is generated based on the first latent space and the noisy image using the diffusion model. In step S730 the linear transformation model is trained based on the first estimated image, the second estimated image, and a loss that enforces a linear change in the linear transformation model.

Example 3. The method of any of the above Examples can further include generating a second latent space or semantic latent space by encoding the image using a semantic encoder and generating the first latent space based on the second latent space using the linear transformation model.

Example 4. The method of any of the above Examples can further include generating a third estimated image based on the second latent space and the noisy image using the diffusion model, generating a fourth estimated image based on the first latent space and the noisy image using the diffusion model, and generating the first estimated image as a weighted average of the third estimated image and the fourth estimated image.

Example 5. The method of any of the above Examples can further include generating a weighted latent space as a weighted average of the first latent space and the second latent space and generating the second estimated image based on the weighted semantic latent space and the noisy image using the diffusion model.

Example 6. The method of any of the above Examples, wherein the semantic encoder, the linear transformation model, and the diffusion model form an autoencoder. The auto encoder can be configured to modify images using a linear transformation in a latent space.

Example 7. The method of any of the above Examples, wherein the linear transformation model can include a classifier with a weight and the training of the linear transformation model includes modifying the weight.

Example 8. The method of any of the above Examples, wherein the linear transformation model can include a classifier with a weight, the weight can be a pixel-wise weight, and the training of the linear transformation model can includes modifying the pixel-wise weight in a region of the first latent space that includes the at least one opacity artifact.

Example 9. The method of any of the above Examples, wherein the region of the first latent space that includes the at least one opacity artifact can be identified using a mask.

Example 10. The method of any of the above Examples, wherein the linear transformation model can include a classifier with a weight, and the loss can be a mean absolute difference between the first estimated image and the second estimated image, with respect to the weight.

Example 11. A method can include any combination of one or more of Example 1 to Example 10.

Example 12. A non-transitory computer-readable storage medium comprising instructions stored thereon that, when executed by at least one processor, are configured to cause a computing system to perform the method of any of Examples 1-11.

Example 13. An apparatus comprising means for performing the method of any of Examples 1-11.

Example 14. An apparatus comprising at least one processor and at least one memory including computer program code, the at least one memory and the computer program code configured to, with the at least one processor, cause the apparatus at least to perform the method of any of Examples 1-11.

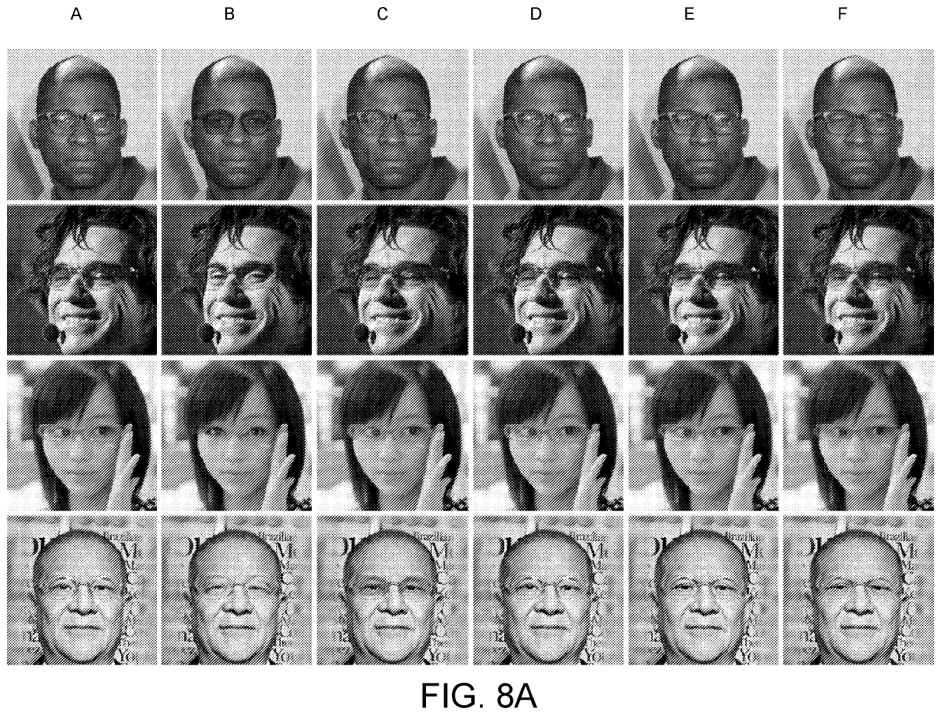

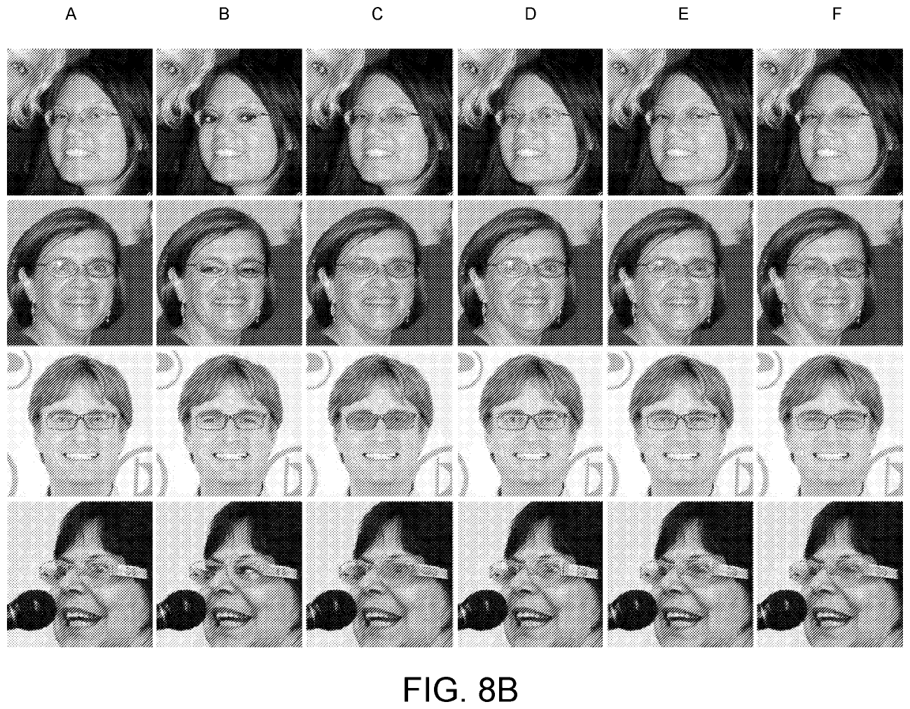

FIGS. 8A and 8B compare the output of the presently described techniques with glare removal techniques that rely on paired inputs. In FIGS. 8A and 8B column A represents the input images with glare, column B represents application of a RePaint model, column C represents application of a RePaint model with a Threshold (applying the inpainting in only the eyeglass regions), column D represents application of an IBCLN model retrained for glare in glasses (rather than reflection in general), column E represents DiffAE trained with “light glare” vs “no glare” and “strong glare” vs “no glare”, and column F represents applications of the disclosed glare removal model of the present disclosure.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
receiving an image including at least one opacity artifact; and
generating an enhanced image by minimizing the at least one opacity artifact using a linear transformation model, wherein the linear transformation model is trained using:
a first estimated image generated based on a first latent space using a diffusion model,
a second estimated image generated based on a noisy image and the first latent space using the diffusion model, and
a loss that enforces a linear change in the linear transformation model,
wherein the first latent space and the noisy image are generated using a same training image and a difference between the first estimated image and the second estimated image is compared to the loss.

2. The method of claim 1, wherein training the linear transformation model comprises:
generating the first latent space by encoding the image using a semantic encoder; and
generating a second latent space based on the first latent space using the linear transformation model.

3. The method of claim 2, wherein training the linear transformation model further comprises:
generating a third estimated image based on the first latent space and the noisy image using the diffusion model;
generating a fourth estimated image based on the second latent space and the noisy image using the diffusion model; and
generating the first estimated image as a weighted average of the third estimated image and the fourth estimated image.

4. The method of claim 2, wherein training the linear transformation model further comprises:
generating a weighted latent space as a weighted average of the first latent space and the second latent space; and
generating the second estimated image based on the weighted latent space and the noisy image using the diffusion model.

5. The method of claim 2, wherein the semantic encoder, the linear transformation model, and the diffusion model form an autoencoder.

6. The method of claim 1, wherein
the linear transformation model includes a classifier with a weight, and
the training of the linear transformation model includes modifying the weight.

7. The method of claim 1, wherein
the linear transformation model includes a classifier with a weight,
the weight is a pixel-wise weight, and
the training of the linear transformation model includes modifying the pixel-wise weight in a region of the second latent space that includes the at least one opacity artifact.

8. The method of claim 7, wherein the region of the second latent space that includes the at least one opacity artifact is identified using a mask.

9. The method of claim 1, wherein
the linear transformation model includes a classifier with a weight, and
the loss is a mean absolute difference between the first estimated image and the second estimated image, with respect to the weight.

10. A method comprising:
receiving an image including a label identifying inclusion of at least one opacity artifact;
generating a first latent space based on the image using a linear transformation model;
generating a noisy image based on the image;
generating a first estimated image based on the first latent space using a diffusion model;
generating a second estimated image based on the first latent space and the noisy image using the diffusion model; and
training the linear transformation model based on the first estimated image, the second estimated image, and a loss that enforces a linear change in the linear transformation model.

11. The method of claim 10, further comprising:
generating a second latent space by encoding the image using a semantic encoder; and
generating the first latent space based on the second latent space using the linear transformation model.

12. The method of claim 11, further comprising:
generating a third estimated image based on the second latent space and the noisy image using the diffusion model;
generating a fourth estimated image based on the first latent space and the noisy image using the diffusion model; and
generating the first estimated image as a weighted average of the third estimated image and the fourth estimated image.

13. The method of claim 11, further comprising:
generating a weighted latent space as a weighted average of the second latent space and the first latent space; and
generating the second estimated image based on the weighted latent space and the noisy image using the diffusion model.

14. The method of claim 11, wherein the semantic encoder, the linear transformation model, and the diffusion model form an autoencoder.

15. The method of claim 11, wherein
the linear transformation model includes a classifier with a weight, and
the training of the linear transformation model includes modifying the weight.

16. The method of claim 11, wherein
the linear transformation model includes a classifier with a weight,
the weight is a pixel-wise weight, and
the training of the linear transformation model includes modifying the pixel-wise weight in a region of the first latent space that includes the at least one opacity artifact.

17. The method of claim 16, wherein the region of the first latent space that includes the at least one opacity artifact is identified using a mask.

18. The method of claim 11, wherein
the linear transformation model includes a classifier with a weight, and
the loss is a mean absolute difference between the first estimated image and the second estimated image, with respect to the weight.

19. A non-transitory computer-readable storage medium comprising instructions stored thereon that, when executed by at least one processor, are configured to cause a computing system to:
receive an image including at least one opacity artifact; and
generate an enhanced image by minimizing the at least one opacity artifact using a linear transformation model, wherein the linear transformation model is trained using:
a first estimated image generated based on a first latent space using a diffusion model,
a second estimated image generated based on a noisy image and the first latent space using the diffusion model, and
a loss that enforces a linear change in the linear transformation model,
wherein the first latent space and the noisy image are generated using a same training image and a difference between the first estimated image and the second estimated image is compared to the loss.

20. (canceled)

21. (canceled)

22. The non-transitory computer-readable storage medium of claim 19, wherein the instructions are further configured to cause the computing system to:
generate the first latent space by encoding the image using a semantic encoder; and
generate a second latent space based on the first latent space using the linear transformation model.
